(19) United States
(12) Patent Application Publication
(10) Pub. No.: US 2003/0067466 A1
(43) Pub. Date: Apr. 10, 2003

(54) Method for using an animated insert which enhances the value of images in infoimaging

(75) Inventors: Thomas M. Stephany, Churchville, NY (US); Donald E. Olson, Rochester, NY (US)

Correspondence Address: Thomas H. Close, Patent Legal Staff, Eastman Kodak Company, 343 State Street, Rochester, NY, 14350-2201, US

(73) Assignee: Eastman Kodak Company

(21) Appl. No.: 09/973,033

(22) Filed: Oct. 9, 2001

(51) Int. Cl. G06T 13/00; G06T 15/70

(52) U.S. Cl. 345/473

(57) ABSTRACT

A method for extracting additional information from an image, the method comprises the steps of obtaining a wire mesh and a texture model; providing instructions for directing the wire mesh which in combination with the wire mesh and texture model forms an animated object; and directing the animated object to deliver audibilized information further defining information contained within the image or content.

### FIELD OF THE INVENTION

The invention relates generally to the field of animations and, more particularly, to using animations for the purpose of deriving more information and value from images or content than is readily apparent, i.e., a form of infoimaging.

### BACKGROUND OF THE INVENTION

The use of animations to deliver entertainment, educational content and specific messages is known. For example, an animation of Smokey Bear was used to teach the public to be careful of starting forest fires. The viewing of cartoons on television has been further demonstrated to be an effective tool for entertainment and learning.

Traditional animations have shortcomings in that they can't be modified as are photo-realistic wire frame animations. Additionally, they are complicated and expensive to produce. Photo-realistic wire frames, therefore, lend themselves to be a better teaching tool, because in the context of any task or learning experience, questions often arise which may require further explanation than existing text or an image alone can or does provide.

There is a need therefore, to use these photo-realistic wire frame animation technologies in a new and novel way, as a vehicle to further describe the content that exists within an image, and further, to deliver additional information in the form of animated help.

### SUMMARY OF THE INVENTION

The present invention is directed to overcoming one or more of the problems set forth above. Briefly summarized, according to one aspect of the present invention, the invention resides in a method for extracting additional information from an image, the method comprising the steps of (a) obtaining a wire mesh and a texture model; (b) providing instructions for directing the wire mesh which in combination with the wire mesh and texture model forms an animated object; and (c) directing the animated object to deliver audibilized information further defining information contained within the image or content.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the following advantage of inserting a digital stand-in into an existing image. This animated digital stand-in who is overlaid serves as a vehicle to further audibilize a description of the image into which it is overlaid. The insert includes the ability to be readily changed, allowing for rapid and inexpensive customization. Plus, the animated agent could be the customized image of a person or thing. Additionally the use of this animation technology is an improvement over the use of video. Compared to video, it can be easily changed, and no acting or actors are required, and the resultant production uses much less storage space than conventional video.

### BRIEF DESCRIPTION OF THE DRAWINGS

FIG. 1 is a block diagram of a hardware implementation of the present invention;

FIG. 2 is a typical frame from an implementation of the present invention; and

FIG. 3 is a flowchart of a software program of the present invention that is implemented of the hardware implementation of FIG. 1.

### DETAILED DESCRIPTION OF THE INVENTION

In the following description, a portion of the present invention will be described in the preferred embodiment as a software program. Those skilled in the art will readily recognize that the equivalent of such software may also be constructed in hardware.

As used herein, an image is defined as, but no limited to, viewable items ranging from text displayed on a computer screen, hardcopy images, outdoor billboard, posters, schematic diagrams, electronic versions of books and the like.

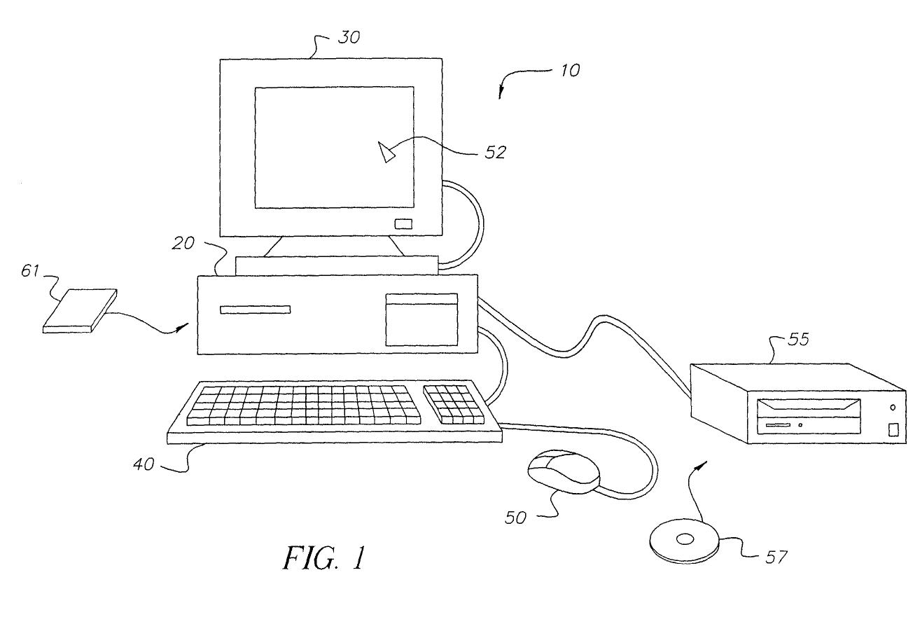

Referring to FIG. 1, there is illustrated a computer system 10 for implementing the present invention. Although the computer system 10 is shown for the purpose of illustrating a preferred embodiment, the present invention is not limited to the computer system 10 shown, but may be used on any electronic processing system. The computer system 10 includes a microprocessor-based unit 20 for receiving and processing software programs and for performing other processing functions. A display 30 is electrically connected to the microprocessor-based unit 20 for displaying user-related information associated with the software. A keyboard 40 is also connected to the microprocessor based unit 20 for permitting a user to input information to the software. As an alternative to using the keyboard 40 for input, a mouse 50 may be used for moving an icon 52 on the display 30 and for selecting an item on which the icon 52 overlays, as is well known in the art.

A compact disk-read only memory (CD-ROM) 55 is connected to the microprocessor based unit 20 for receiving software programs and for providing a means of inputting the software programs and other information to the microprocessor based unit 20 via a compact disk 57, which typically includes a software program. In addition, a floppy disk 61 may also include a software program, and is inserted into the microprocessor-based unit 20 for inputting the software program. Still further, the microprocessor-based unit 20 may be programmed, as is well know in the art, for storing the software program internally.

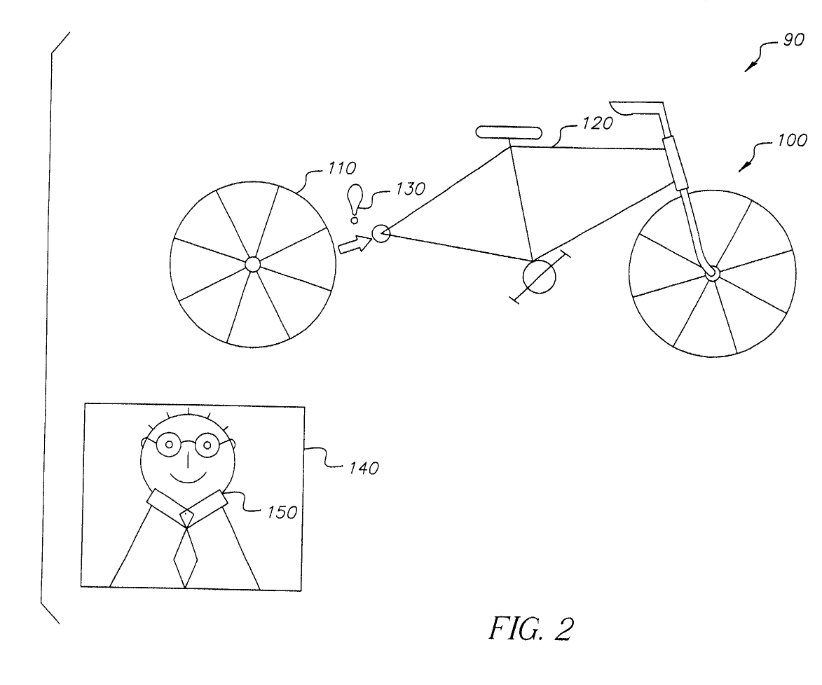

Referring next to FIG. 2, there is a typical frame from the implementation of the present invention. The background 90 shows a schematic diagram for the assembly of a product, in this case a bicycle 100. The rear wheel 110 is shown to be assembled to the back of frame 120. An exclamation point 130 exists to alert a customer that special care must be taken at this point in the assembly. If the customer clicks the mouse 50 (from FIG. 1), on the asterisk 130, the foreground insert 140 having the animated agent 150 is initiated. Animated agent refers to a database X shown in the software flowchart X which gives instructions to the animated agent 150 causing said agent to deliver the additional information or explanation required. It is instructive to note that a superimposed animated agent may be used in lieu of a fixed foreground.

It should be noted here that this technology would be extremely useful in a variety of situations, but especially with existing images where further explanation of details concealed within the image would be valuable. Additionally, it would also lend itself to be an animated help agent such as within a software program.

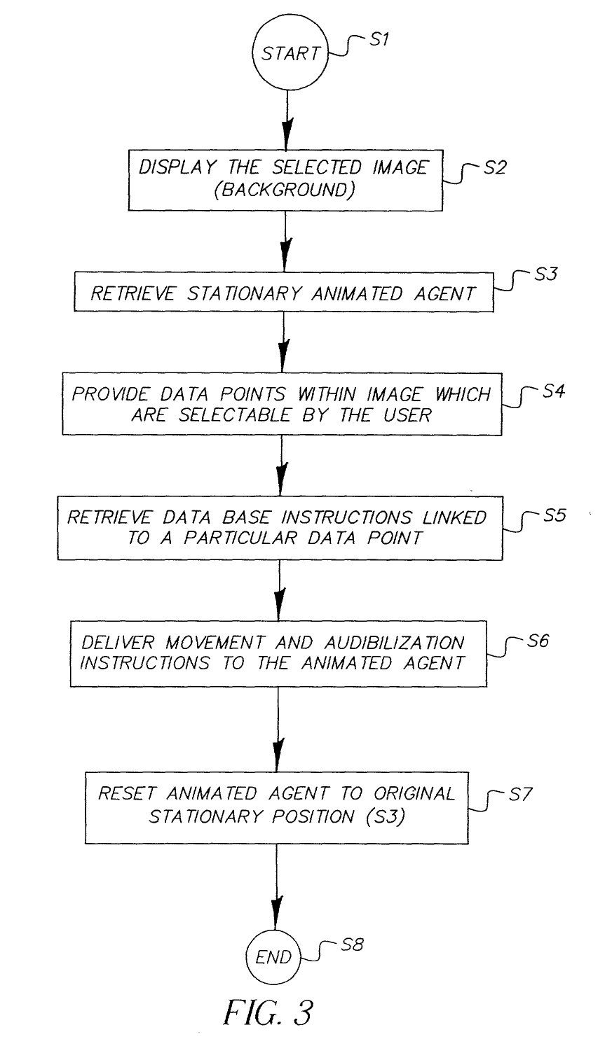

Referring to FIG. 3, there is shown the flowchart of a software program of the present invention. The system control software is started S1 by pressing any key on the keyboard 40, (FIG. 1). The software displays S2 a predetermined image, i.e., the background, on the monitor 30. The software then retrieves S3 a stationary animated agent. Data points are provided within the image, which allow a user to retrieve additional information. Database instructions (movement and audibilized information) are retrieved S5 for providing the content of the additional information. These database instructions are delivered S6 to the animated agent for initialing the movement and audibilization of the animated agent. The animated is reset S7 to its original station position for the purpose of delivering additional content about the image, one form of infoimaging. The software is then terminated S8.

The invention has been described in detail with particular reference to certain preferred embodiments thereof, but it will be understood that variations and modifications can be effected within the spirit and scope of the invention.

### Parts List

10 computer

20 microprocessor

30 monitor

40 keyboard

50 mouse

52 icon

55 CD-ROM drive

57 CD-ROM disc

61 floppy disk drive

90 foreground

100 bicycle

110 rear wheel

120 frame

130 exclamation point

140 foreground

150 animated agent

What is claimed is:

1. A method for extracting additional information from an image, the method comprising the steps of:
(a) obtaining a wire mesh and a texture model;
(b) providing instructions for directing the wire mesh which in combination with the wire mesh and texture model forms an animated object; and
(c) directing the animated object to deliver audibilized information further defining information contained within the image or content.

2. The method as in claim 1 further comprising a database containing information which provides the audibilized information.

3. The method as in claim 1, wherein the animated object is either in the foreground or superimposed on the image.

4. The method as in claim 1, wherein step (c) includes selecting an object in the image for initializing the audibilization.
